(19) United States
(12) Patent Application Publication
(10) Pub. No.: US 2024/0069947 A1
(43) Pub. Date: Feb. 29, 2024

(54) USING VIRTUAL MACHINE (VM) PRIORITIES FOR DETERMINING PATHS THAT SERVE THE VMs

(71) Applicant: International Business Machines Corporation, Armonk, NY (US)

(72) Inventors: Esdras E. Cruz-Aguilar, Round Rock, TX (US); Jes Kiran Chittigala, Kukatpally (IN); Santhosh S. Joshi, Miyapur (IN); Ravi A. Shankar, Austin, TX (US); Perinkulam I. Ganesh, Round Rock, TX (US); Michael S. Fuller, Pflugerville, TX (US)

(21) Appl. No.: 17/895,688

(22) Filed: Aug. 25, 2022

(51) Int. Cl. G06F 9/455; G06F 9/48; G06F 11/14

(52) U.S. Cl. CPC G06F 9/45558; G06F 9/4831; G06F 11/1407; G06F 2009/45595

(57) ABSTRACT

A computer-implemented method according to one embodiment includes assigning a priority to virtual machines (VMs), and obtaining pathing information for the VMs. At least one of the VMs assigned a relatively higher priority is selected to perform a process over at least one of the VMs assigned a relatively lower priority. A computer program product according to another embodiment includes a computer readable storage medium having program instructions embodied therewith. The program instructions are readable and/or executable by a computer to cause the computer to perform the foregoing method. A system according to another embodiment includes a processor, and logic integrated with the processor, executable by the processor, or integrated with and executable by the processor. The logic is configured to perform the foregoing method.

### BACKGROUND

The present invention relates to virtual machines (VMs), and more specifically, this invention relates to determining paths that serve VMs.

A typical virtual server deployment serving a client logical partition or virtual machine (VM) may consider redundant pathing from the VM to storage. These paths come by way of virtual fiber channels (FCs) created at the VM side and at a virtual server side. The virtual server then maps these paths to physical FCs to provide access to the storage. Accordingly, a virtual server may be aware of the paths of each VM that the virtual server serves.

### SUMMARY

A computer-implemented method according to one embodiment includes assigning a priority to virtual machines (VMs), and obtaining pathing information for the VMs. At least one of the VMs assigned a relatively higher priority is selected to perform a process over at least one of the VMs assigned a relatively lower priority.

A computer program product according to another embodiment includes a computer readable storage medium having program instructions embodied therewith. The program instructions are readable and/or executable by a computer to cause the computer to perform the foregoing method.

A system according to another embodiment includes a processor, and logic integrated with the processor, executable by the processor, or integrated with and executable by the processor. The logic is configured to perform the foregoing method.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one embodiment of the present invention.

FIG. 2A is a flowchart of a method, in accordance with one embodiment of the present invention.

FIG. 2B is a flowchart of sub-operations of an operation of the flowchart of FIG. 2A.

FIG. 2C is a flowchart of sub-operations of a sub-operation of the flowchart of FIG. 2B.

FIGS. 3A-3B is a representation of a virtual server deployment, in accordance with one embodiment of the present invention.

FIG. 4A is a diagram of a topology of clusters of a virtual server environment, in accordance with one embodiment of the present invention.

FIG. 4B is a diagram of a topology of a takeover process within a cluster of the topology of FIG. 4A, in accordance with one embodiment of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods, and computer program products for using virtual machine (VM) priorities for determining paths that serve the VMs.

In one general embodiment, a computer-implemented method includes assigning a priority to virtual machines (VMs), and obtaining pathing information for the VMs. At least one of the VMs assigned a relatively higher priority is selected to perform a process over at least one of the VMs assigned a relatively lower priority.

In another general embodiment, a computer program product includes a computer readable storage medium having program instructions embodied therewith. The program instructions are readable and/or executable by a computer to cause the computer to perform the foregoing method.

In another general embodiment, a system includes a processor, and logic integrated with the processor, executable by the processor, or integrated with and executable by the processor. The logic is configured to perform the foregoing method.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

Computing environment 100 contains an example of an environment for the execution of at least some of the computer code involved in performing the inventive methods, such as inventive code in block 200 for selecting the virtual machines (VMs) assigned relatively higher priorities over the VMs assigned relatively lower priorities to perform a process. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

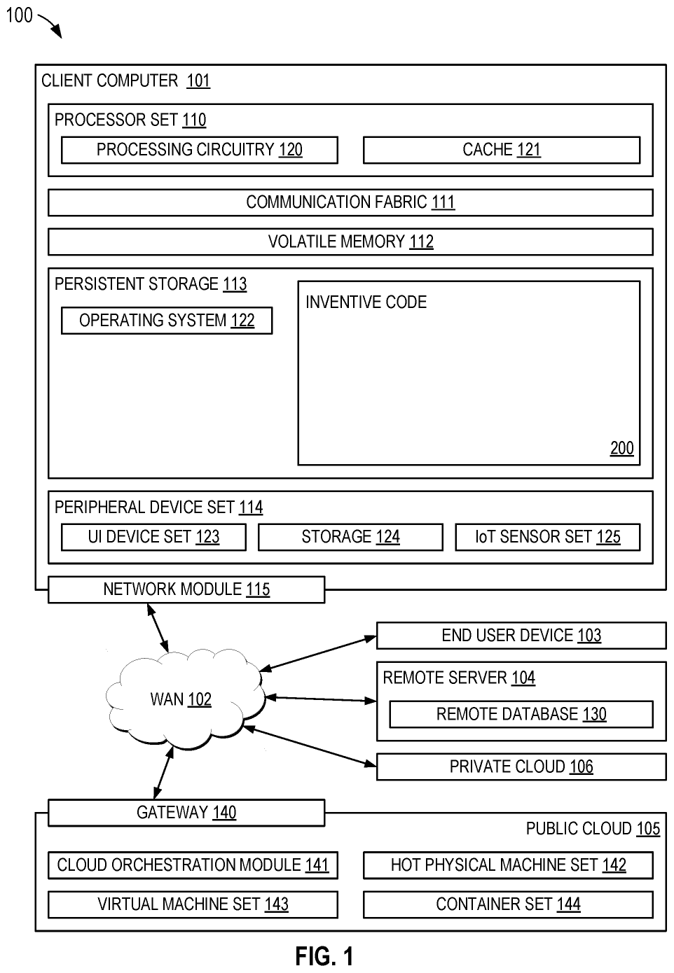

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

As mentioned elsewhere herein, a typical virtual server deployment serving a client logical partition or VM considers redundant pathing from the VM to storage. These paths come by way of virtual FCs created at the VM side and at a virtual server side. The virtual server then maps these paths to physical FCs to provide access to the storage. Accordingly, a virtual server may be aware of the paths of each VM that the virtual server serves.

While some VMs may at least temporarily lose some paths to storage while maintaining other paths, for various reasons some VMs may at least temporarily experience a loss of all paths to storage. The storage oftentimes contains a root volume group (rootvg) of the VM, meaning that if the storage does not have access to the VM, the VM is no longer functioning. The storage may also contain other critical information for which applications in the VM require access. Some conventional techniques attempt to limit downtime of these VMs by attempt to move the VM to another host, e.g., such as by issuing a DR restart upon experiencing a disaster event. However, this may not be possible. For example, the destination hosts may not be available, or the destination hosts may be at capacity and therefore not have an ability to house the VM. Some other conventional techniques attempt to limit downtime of these VMs by manually or automatically attempting to troubleshoot a cause of the VM disaster event, and furthermore attempting to restore a previously configured path to the VM that experienced the disaster event. However, an issue with such techniques arises when the path is indeterminately down for an unknown reason, or not capable of being restored.

In sharp contrast to the deficient conventional techniques described above, various embodiments and approaches described herein include determining whether a path can be transferred to another VM. More specifically, various embodiments and/or approaches described herein enable re-routing of virtual fiber channels from VMs assigned relatively lower priorities to VMs assigned relatively higher priorities. This way the VMs assigned relatively higher priorities continue to run in a native site or get migrated to a remote site. Various embodiments and approaches described herein include dynamically determining the paths of each VM and then taking actions to remove a path of a VM in preference of another VM. In order to achieve these tasks, such embodiment and approaches may include assigning a preference or priority to the VMs. Furthermore, where a VM is being moved to another host that cannot be hosted due to pathing being unavailable, the same algorithm to move a path may be used to accommodate the higher priority VM. On the target host, it is determined which paths are available, and moving is performed as needed so that the moving VM can complete. Often, there are multiple virtual servers that can serve a VM. An orchestrator coordinates the virtual server selection once the paths are moved. For this, the logic preferably resides outside of the virtual server to make this determination. A lower priority VM may have one or all paths removed in preference of the higher priority VM. If a path remains, both the low and high priority VM can be active.

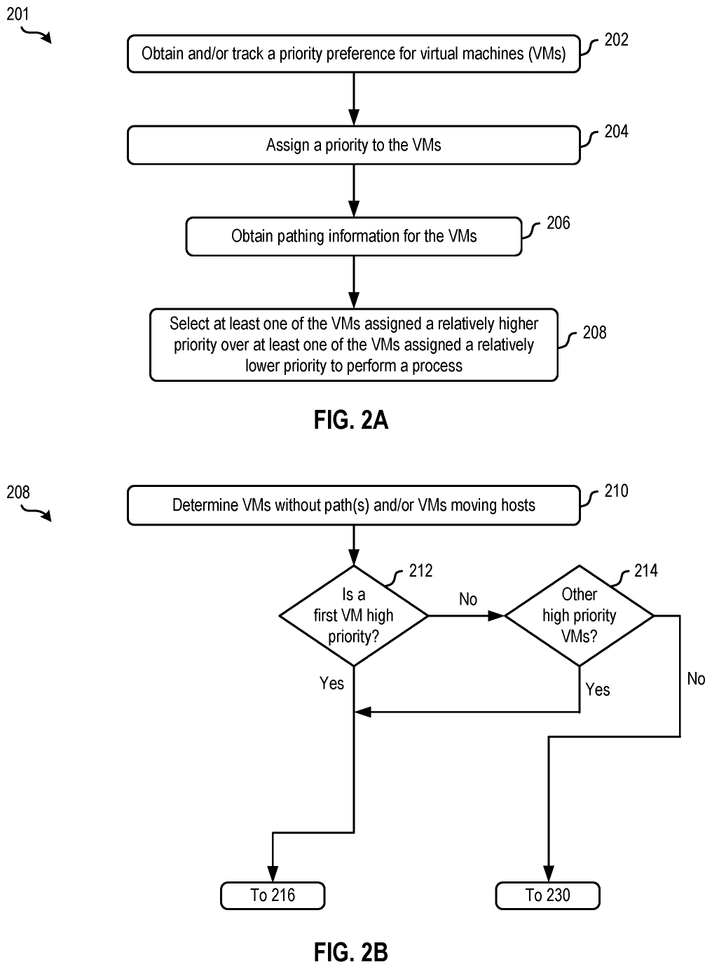

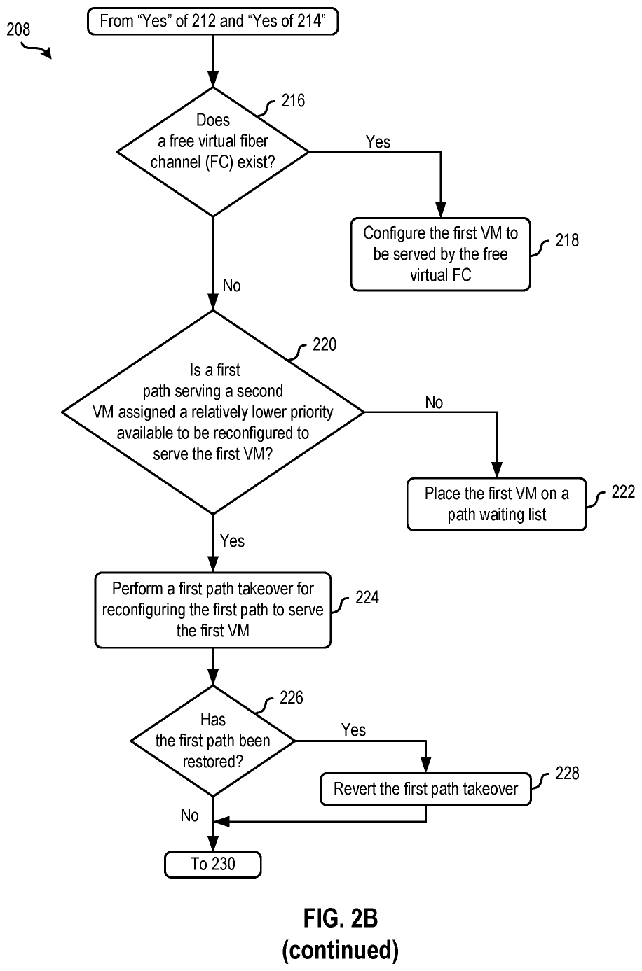

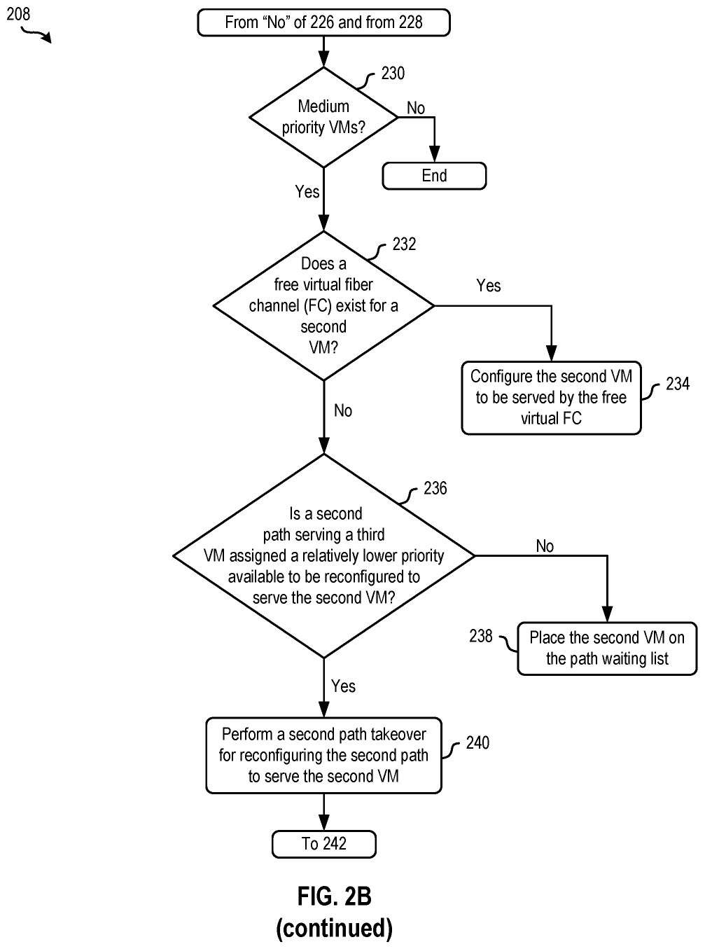

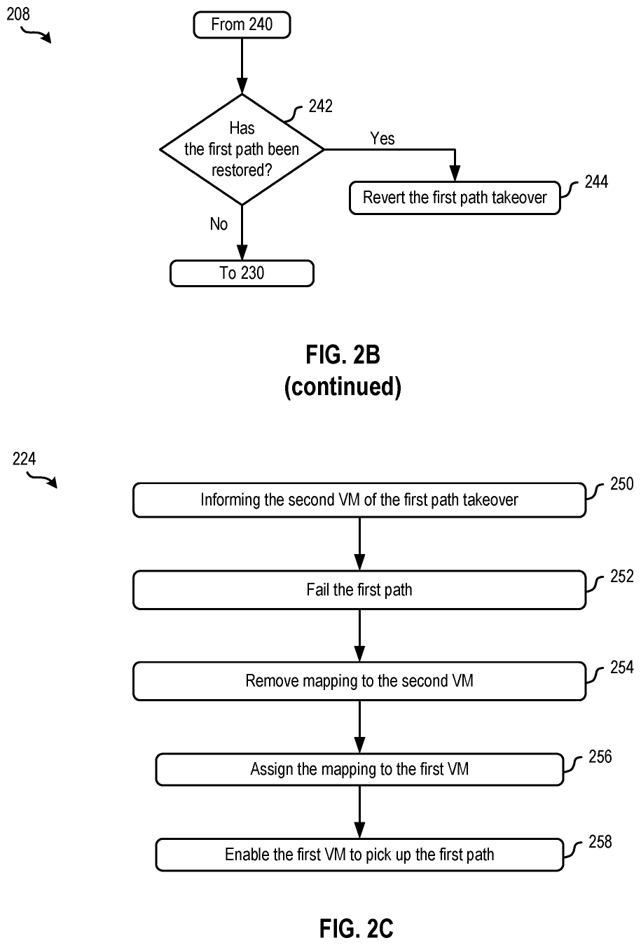

Now referring to FIG. 2, a flowchart of a method 201 is shown according to one embodiment. The method 201 may be performed in accordance with the present invention in any of the environments depicted in FIGS. 1-3B, among others, in various embodiments. Of course, more or fewer operations than those specifically described in FIG. 2 may be included in method 201, as would be understood by one of skill in the art upon reading the present descriptions.

Each of the steps of the method 201 may be performed by any suitable component of the operating environment. For example, in various embodiments, the method 201 may be partially or entirely performed by a computer, or some other device having one or more processors therein. The processor, e.g., processing circuit(s), chip(s), and/or module(s) implemented in hardware and/or software, and preferably having at least one hardware component may be utilized in any device to perform one or more steps of the method 201. Illustrative processors include, but are not limited to, a central processing unit (CPU), an application specific integrated circuit (ASIC), a field programmable gate array (FPGA), etc., combinations thereof, or any other suitable computing device known in the art.

It may be prefaced that method 201 may be performed using orchestrating software, such as Virtual Machine Recovery Manager (VMRM) by IBM, that is configured to perform various of the operations described below within a virtual server deployment, e.g., such as a virtual input/output server (VIOS) deployment by IBM. This orchestrating software is important in some approaches because a virtual server of the virtual server deployment may only be aware of itself in a deployment and not be aware of other virtual servers. In some approaches, the virtual server deployment may include a known type of controlling system having one or more hosts with virtual servers thereon, that is modified to be configured to cause, e.g., issue instructions, one or more of the operations described in method 201 to be performed. The controlling system may communicate with one or more computers, where each of such computers acts as a host monitor controller for virtual servers within a host that the computer manages. Such a host may additionally and/or alternatively include at least one virtual machine (VM) that communicates with the virtual servers and/or storage along a virtual local area network (VLAN) connections. In another approach, the virtual server deployment may additionally and/or alternatively include at least a first virtual server and a second virtual server. Each of the virtual servers may include at least one physical fiber channel adapter which may be of a known type. Such adapters may communicate with a storage area network (SAN) that is connected to physical storage. Each of the virtual servers may additionally and/or alternatively include at least one server virtual fibre channel adapter that is connected to at least one VM via at least one pathway.

Operation 202 includes obtaining and/or tracking a priority preference for the VMs. In some preferred approaches, priority preferences are obtained and/or tracked for each of the VMs of a virtual server deployment, which may include one or more virtual servers. More specifically, the mapping of FCs from all of the virtual servers to VMs is obtained. In some approaches the mapping may be obtained by an orchestrator of the virtual server deployment that is configured to probe each virtual server and obtain mapping information. In some other approaches, priority preferences may be obtained and/or tracked using known techniques for determining, from mapping, an extent of use that the VMs are associated during operation of the virtual server deployment. The priority preferences may additionally and/or alternatively be obtained and/or tracked using known techniques for determining an extent of requests that are associated with the VMs during operation of the virtual server deployment.

A priority, e.g., a priority preference, is assigned to VMs of the virtual server deployment. In some approaches only some of the VMs are assigned a priority, e.g., see operation 204. In some preferred approaches, each of the VMs of the virtual server deployment are assigned a priority. The priorities are in some preferred approaches based on three priority tiers. For example, the priorities may include relatively lower priority, relatively medium priority, and relatively higher priority, where the relatively medium priority is relatively lower priority than the relatively higher priority, and the relatively lower priority is relatively lower priority than the relatively medium priority. In some other approaches the priorities may be based on two priority tiers, e.g., relatively lower priority and relatively higher priority where the relatively lower priority is relatively lower priority than the relatively higher priority. In yet some further approaches, the priorities may be scores of a predetermined range of values. For example, within a predetermined range of ten, relatively lower priority VMs may have an assigned score of one through four, relatively medium priority VMs may have an assigned score of five through seven, and relatively higher priority VMs may have an assigned score of eight through ten. The priorities of the VMs are in some approaches assigned and thereafter optionally modified according to the tracking performed for each of the VMs. Such modification may in some approaches only occur subsequent to each of the VMs being considered in various operations described below, e.g., see operation 208. In some other approaches, assignment of the priorities is kept for at least a predetermined amount of time. The priorities may in some approaches be set based on workload preferences. For example, a first workload of a VM that is preferably continually run may be assigned a high priority, while a second workload of a VM that is preferably run provided that a predetermined extent of resources are available in a VM may be assigned a relatively medium priority, while a third workload of a VM that is preferably run only during scheduled downtime of a VM may be assigned a low priority. In another example, a production workload of a VM may be assigned a high priority, while a test workload of a VM may be assigned a low priority.

Pathing information for the VMs is obtained, e.g., see operation 206. The pathing information is preferably information that defines one or more paths that are currently established between the VMs and server fibre channel adapter(s) of virtual servers thereby serving as communication paths. More specifically, the pathing information preferably details which paths are currently serving which of the VMs. The pathing information is in some approaches obtained by issuing a mapping information query to all the virtual servers of the virtual server deployment, e.g., such as where a query is issued for all existing pathing information in the virtual server deployment.

Operation 208 includes selecting at least one of the VMs assigned a relatively higher priority over at least one of the VMs assigned a relatively lower priority to perform a process. The process may include using at least one of the VMs having a relatively higher priority than at least one of the VMs having a relatively lower priority for one or more known type of I/O operations in the virtual server deployment, e.g., such as disaster recovery-based I/O operations. In another approach, the process may include using VMs having relatively higher priorities than other VMs having relatively lower priorities to fulfill requests for relatively frequently requested data. In yet another approach, the process may include limiting the time that recovering from a disaster event takes. For example, subsequent to experiencing a disaster event, paths of the VMs may be restored by applying the techniques of method 201 to ensure that VMs assigned relatively high priorities are prioritized in path assignment over VMs assigned relatively lower priorities. Moreover, the recovery process may be automated and does not call for troubleshooting which is sometimes relied on in conventional approaches to recover from a disaster event. As will now be described below, e.g., see FIGS. 2B-2C, VMs having such relatively higher priorities are preferably provided a free virtual fiber channel (FC) on the virtual server deployment that can serve the VM assigned the relatively higher priority, provided that a free virtual FC is available. A path of the free virtual FC may thereafter be used to serve the VM assigned the relatively higher priority in order to perform the aforementioned operation. Moreover, the virtual server may thereby serve the VM based on the established path. Furthermore, in the event that a virtual FC is not free to serve the VM assigned the relatively higher priority, an established path being used by a VM with a relatively lower priority may be taken over to enable the operation to be performed thereafter.

Looking to FIG. 2B, exemplary sub-operations of selecting the VMs assigned relatively higher priorities over the VMs assigned relatively lower priorities to perform a process are illustrated in accordance with one embodiment, one or more of which may be used to perform operation 208 of FIG. 2A. However, it should be noted that the sub-operations of FIG. 2B are illustrated in accordance with one embodiment which is in no way intended to limit the invention.

Sub-operation 210 includes determining VMs without path(s) and/or VMs moving hosts. In some approaches, the VMs without path(s) may be determined from the pathing information. For example, a list of the VMs may be compared with VMs indicated within the pathing information to be associated with using a path. In such an example, VMs that do not match VMs indicated within the pathing information to be associated with using a path may be identified as VMs without path(s). These VMs may be determined to not be currently accommodated by any path. In some other approaches, one or more techniques that would become apparent to one of ordinary skill in the art upon reading the descriptions herein may additionally and/or alternatively be utilized for determining VMs moving hosts, e.g., from a first host of the virtual server deployment to a second host of the virtual server deployment. For example, VMs that are moving hosts may be identified using results of a query, identified in a queue, etc.

If it is determined that the there are no VMs without path(s) or moving hosts, the method optionally ends. In contrast, assuming that at least a first VM is determined to be without path(s) or moving hosts, it is determined whether the first VM is assigned a high priority, e.g., see sub-operation 212. It should be noted that various sub-operations of FIG. 2B are performed from a perspective in which the priorities include a relatively higher priority, a relatively medium priority, and a relatively lower priority. For context, in some approaches, a relatively medium priority is relatively lower priority than a relatively higher priority, and a relatively lower priority is relatively lower priority than a relatively medium priority. Although in some approaches, a portion of such sub-operations may be performed from a perspective in which the priorities include high and low. For context, in some approaches, a relatively lower priority is relatively lower priority than a relatively higher priority.

VMs assigned a relatively higher priority are prioritized in various sub-operations of FIG. 2B. Accordingly, in response to a determination that the first VM is not assigned a high priority, e.g., as illustrated by the “No” logical path of sub-operation 212, it is determined whether another of the VMs are assigned a high priority, e.g., see sub-operation 214. In response to a determination that another of the VMs are assigned a relatively higher priority, e.g., as illustrated by the “Yes” logical path of sub-operation 214, the sub-process optionally continues to sub-operation 216. Furthermore, in response to a determination that the first VM is assigned a relatively higher priority, e.g., as illustrated by the “Yes” logical path of sub-operation 212, the sub-process optionally continues to sub-operation 216.

In response to a determination that the first VM is assigned the high priority, it may be determined whether a free virtual fiber channel (FC) exists that can serve the first VM, e.g., see sub-operation 216. Note that a virtual system may serve the VM based on the established path. For context, in some approaches, a free virtual FC may be a path that is not currently serving any of the VMs of a virtual system deployment. This may be determined from the pathing information, e.g., a path that is not servicing any VM within the pathing information. In another approach, a free virtual FC may be a path that is scheduled to stop serving at least one of the VMs of the virtual server deployment, e.g., termination of the path is scheduled within a predetermined amount of time.

In response to a determination that a free virtual fiber channel (FC) exists, e.g., as illustrated by the “Yes” logical path of sub-operation 216, the first VM is configured to be served by the free virtual FC, e.g., see sub-operation 218. In some other approaches, one or more techniques that would become apparent to one of ordinary skill in the art upon reading the descriptions herein may be utilized for configuring the first VM to be served by the free virtual FC. In some approaches, a mapping from a virtual server to the first VM along a path may be assigned to the first VM to configure the first VM to be served by the free virtual FC. Known techniques may additionally and/or alternatively be used to cause, e.g., instruct, the first VM to pick up the path.

In contrast, in response to a determination that a free virtual FC does not exist, e.g., on a virtual system, to serve the first VM, e.g., as illustrated by the “No” logical path of sub-operation 216, it is determined, from the pathing information, whether a first path, serving a second VM assigned a relatively lower priority than the priority assigned to the first VM, is available to be reconfigured to serve the first VM. Note that depending on the approach, the second VM may be connected to a virtual server that the first VM is connected to, or alternatively be connected to another virtual system that the first VM is not connected to, e.g., a target host virtual server. In one approach the first path is a virtual FC. According to a more specific approach, sub-operation 220 may include determining whether any VMs assigned a medium priority have a path that may be used to serve the first VM. In yet another approach, sub-operation 220 may additionally and/or alternatively include determining whether any VMs assigned a low priority have a path that may be used to serve the first VM. Assuming that VMs assigned a relatively lower priority than the priority assigned to the first VM have a path, a determination of whether the path may be used to serve the first VM may be based on one or more variables. For example, determination of whether the path may be used to serve the first VM may be determined based on whether the path is being actively used for an I/O operation. In some approaches, only paths that are not being actively used for I/O operations may be taken over for reconfiguring, while paths that are being actively used for I/O operations may not be taken over for reconfiguring. In another approach, determination of whether the path may be used to serve the first VM may be determined based on whether the path has gone unused for at least a predetermined amount of time. In such an approach, only paths that have not been used for at least the predetermined amount of time may be taken over for reconfiguring, while paths that have been used within the predetermined amount of time may not be taken over for reconfiguring. In yet another approach, any path serving a VM having an assigned priority that is lower than the priority assigned to the first VM, e.g., high priority, may be taken over. When taking over one or more VMs for serving a relatively higher priority VM, it may be preferable to maintain function of as many VMs as possible, e.g., taking over one path of a VM having two paths and assigned a low priority may be preferred over taking over one path of a VM having one paths and assigned a low priority in some approaches.

As noted in sub-operation 222, in response to a determination that the first path is not available to be reconfigured to serve the first VM, e.g., as illustrated by the “No” logical path of sub-operation 220, the first VM is optionally placed on a path waiting list, e.g., a first in-first out queue that includes entries that are associated with VMs that request a path. In contrast, in response to a determination that the first path is available to be reconfigured to serve the first VM, e.g., as illustrated by the “Yes” logical path of sub-operation 220, a first path takeover may be performed for reconfiguring the first path to serve the first VM, e.g., see sub-operation 224. Illustrative techniques for performing a path takeover, e.g., such as a takeover of the first path, is described in greater detail elsewhere below, e.g., see FIG. 2C. Note that this process may be dynamically performed in some approaches to ensure that relatively higher priority VMs are assigned paths over relatively lower priority VMs.

The first VM is preferably configured to be served by the first path, e.g., a free virtual FC, as a result of the first path takeover being performed. One or more operations, e.g., I/O operations, may be performed using the first VM and the first path as a result of the configuration. However, at some point after configuration of the first VM and the first path, a path that was failed to establish the configuration of the first path and the first VM may be restored. For example, subsequent to failing a path being used by a second VM to free the path for the first VM the failed path may be restored. Accordingly, it may be determined whether the failed first path has been partially or fully restored, e.g., see sub-operation 226. In some approaches a determination of whether the failed first path has been restored may be based on updated pathing information. For example, updated pathing information may be obtained by issuing a query subsequent to failing the first path and/or the path being configured to serve the first VM. Note that a failed path being restored may indicate that the failed path was relatively more useful to fulfilling I/O operations within the virtual server than configuring the path to serve the first VM is. In response to a determination that the failed first path has been restored, e.g., as illustrated by the “Yes” logical path of sub-operation 226, the first path takeover may be reverted, e.g., see sub-operation 228. The restore may be a partial restore or alternatively a full restore. In one optional approach, a priority assigned to the second VM, e.g., the VM that is served by the first path before being failed, may be adjusted based on the first path being reverted. For example, assuming that the second VM is originally assigned a low priority, the priority of the second VM may be adjusted to medium priority subsequent to the first path takeover being reverted. In another example, assuming that the second VM is originally assigned a medium priority, the priority of the second VM may be adjusted to high priority subsequent to the first path takeover being reverted.

In response to a determination that the failed first path has not been restored, e.g., as illustrated by the “No” logical path of sub-operation 226, the sub-process optionally continues to sub-operation 230 and it is determined whether any of the VMs determined to be without path(s) or to be moving to other hosts are medium priority VMs. It should be noted that such a determination may in some approaches be performed in response to a determination that there are no other high priority VMs that are not being served by a path, e.g., see “No” logical path of sub-operation 214.

In response to a determination that there are no VMs assigned a medium priority, as illustrated by the “No” logical path of sub-operation 230, the sub-process of FIG. 2B optionally ends, e.g., see “End.” In contrast, in response to a determination that there are VMs assigned a medium priority, e.g., hereafter referred to as a “second VM,” that are not served by a path, e.g., as illustrated by the “Yes” logical path of sub-operation 230, it may be determined whether a free path, e.g., virtual FC, exists, e.g., on the virtual server for the second VM, e.g., see sub-operation 232. Note that it may be assumed that the second VM is assigned a medium priority in various approaches below. In response to a determination that a free path, e.g., a virtual FC, exists for the second VM, e.g., as illustrated by the “Yes” logical path of sub-operation 232, the second VM is configured to be served by the free virtual FC, e.g., see sub-operation 234.

In response to a determination that a free path, e.g., a virtual FC, does not exist for the second VM, e.g., as illustrated by the “No” logical path of sub-operation 232, it may be determined whether a second path serving a third VM is available to be reconfigured to serve the second VM. In some approaches the third VM may be on the same host cluster as the second VM, or alternatively may be on a different host cluster as the second VM, e.g., where each cluster is managed by a different known type of manager. Note that such a determination may be performed using the pathing information and/or using similar techniques described elsewhere herein for determining whether a first path serving a second VM is available to be reconfigured to serve the first VM. In some approaches in which a third VM is available, it may be also assumed in various examples below that the third VM is assigned a relatively lower priority than the priority assigned to the second VM. Accordingly, the third VM may be assigned a relatively lower priority, e.g., the third VM is assigned low priority, while the second VM is assigned a relatively lower priority that is relatively higher priority than the priority of the third VM, e.g., the second VM is assigned medium priority, while the first VM is assigned a relatively high priority that is relatively higher priority than the priorities assigned to the second VM and the third VM, e.g., the first VM is assigned high priority. As noted in sub-operation 238, in response to a determination that the second path is not available to be reconfigured to serve the second VM, e.g., as illustrated by the “No” logical path of sub-operation 236, the second VM is optionally placed on a path waiting list, e.g., a first in-first out queue that includes entries that are associated with VMs that request a path. In contrast, in response to a determination that the second path is available to be reconfigured to serve the second VM, e.g., as illustrated by the “Yes” logical path of sub-operation 236, a second path takeover may be performed for reconfiguring the second path to serve the second VM, e.g., see sub-operation 240. Illustrative techniques described elsewhere herein for performing a first path takeover may be modified to perform the second path takeover in some approaches.

The second VM is preferably configured to be served by the second path, e.g., a free virtual FC, as a result of the second path takeover being performed. One or more operations, e.g., I/O operations, may be performed using the second VM and the second path as a result of the configuration. However, at some point after configuration of the second VM and the second path, a path that was failed to establish the configuration of the second path and the second VM may be restored. For example, subsequent to failing a path being used by a third VM to free the path for the second VM, the failed path may be restored. Accordingly, it may be determined whether the failed second path has been restored, e.g., see sub-operation 242. In some approaches a determination of whether the failed second path has been restored may be based on updated pathing information. For example, updated pathing information may be obtained by issuing a query subsequent to failing the second path and/or the path being configured to serve the second VM. Note that a failed path being restored may indicate that the failed path was relatively more useful to fulfilling I/O operations within the virtual server than configuring the path to serve the second VM is. In response to a determination that the failed second path has been restored, e.g., as illustrated by the “Yes” logical path of sub-operation 242, the second path takeover may be reverted, e.g., see sub-operation 244. In one optional approach, a priority assigned to the third VM, e.g., the VM that is served by the second path before being failed, may be adjusted based on the second path being reverted. For example, assuming that the third VM is originally assigned a low priority, the priority of the third VM may be adjusted to medium priority subsequent to the second path takeover being reverted. In another example, assuming that the third VM is originally assigned a medium priority, the priority of the third VM may be adjusted to high priority subsequent to the second path takeover being reverted.

In response to a determination that the failed second path has not been restored, e.g., as illustrated by the “No” logical path of sub-operation 242, the sub-process optionally continues to sub-operation 230 and it is determined whether any additional of the VMs determined to be without path(s) or to be moving to other hosts are medium priority VMs. In response to a determination that there are not any additional VMs assigned a medium priority, the sub-process optionally ends, e.g., see “End.”

Looking to FIG. 2C, exemplary sub-operations of performing a path takeover are illustrated in accordance with one embodiment, one or more of which may be used to perform sub-operation 224 of FIG. 2B. However, it should be noted that the sub-operations of FIG. 2C are illustrated in accordance with one embodiment which is in no way intended to limit the invention.

Sub-operation 250 includes informing the second VM of the first path takeover. Informing the second VM of the first path takeover may in some approaches include issuing an instruction for the second VM to complete I/O operations that are in progress and/or not accept new I/O operations. This may ensure that failing the path does not disturb ongoing I/O or quiesce. In one example an external orchestrator may be utilized to shut down the VM. Subsequent to informing the second VM of the first path takeover, the first path may be failed, e.g., see sub-operation 252. Failing a path may include issuing a redirect command for I/O operations that were intended for the second VM to be issued to the first VM on a new path. Failing the first path may additionally include removing information about the first path in the pathing information. For example, mapping is removed to the second VM, e.g., from the virtual server, in some approaches, e.g., see sub-operation 254. The mapping may be thereafter assigned to the first VM, e.g., see sub-operation 256. This enables the first VM to be served by the first path. The first VM is also enabled to pick up the first path, e.g., see sub-operation 258. Enabling the first VM to pick up the first path may include issuing an instruction for the first VM to connect to one or more portions of the virtual server deployment using the first path. In another approach, an instruction may be issued for the first VM to perform an action to pick up the new path. For example, instruction may be issued for the first VM to perform an action that includes activating a shutdown, rebooting, etc.

Similar techniques to those described in the sub-operations of FIG. 2C may be used to performing the second path takeover. For example, performing the second path takeover may include informing the third VM of the second path takeover, and failing the second path. The mapping may be removed to the third VM, e.g., from the virtual server. Furthermore, the mapping may be assigned to the second VM, and the second VM is enabled to pick up the second path.

Various benefits are enabled as a result of utilizing techniques of various of the embodiments and approaches described herein. For example, using VM priorities for determining paths to serve the VMs has heretofore not been considered in the techniques of conventional approaches. In sharp contrast, in conventional approaches the paths of a virtual server are distributed among VMs without considering priorities of the VMs. This is problematic because within these conventional deployments, attempts to limit downtime include attempting to move a VM to another host without considering path priorities. However, in the event that the destination host is not available and/or or the destination host is at capacity, e.g., there are no paths available to connect to the moving VM, the VM cannot move to another host. As a result of these conventional techniques, VMs should otherwise be prioritized are not, which ultimately downgrades the performance potential of a virtual server. In sharp contrast, as a result of using the techniques of various embodiments and approaches described herein performance of a virtual server and computer related components therein is increased as VMs having relatively higher priorities are prioritized over VMs having relatively lower priorities. More specifically, in the event that a path is not available for a VM assigned a relatively higher priority, a path being used by a VM assigned a relatively lower priority is taken over. Accordingly, the inventive discoveries disclosed herein with regards to use of VM priorities for determining paths within virtual servers proceed contrary to conventional wisdom.

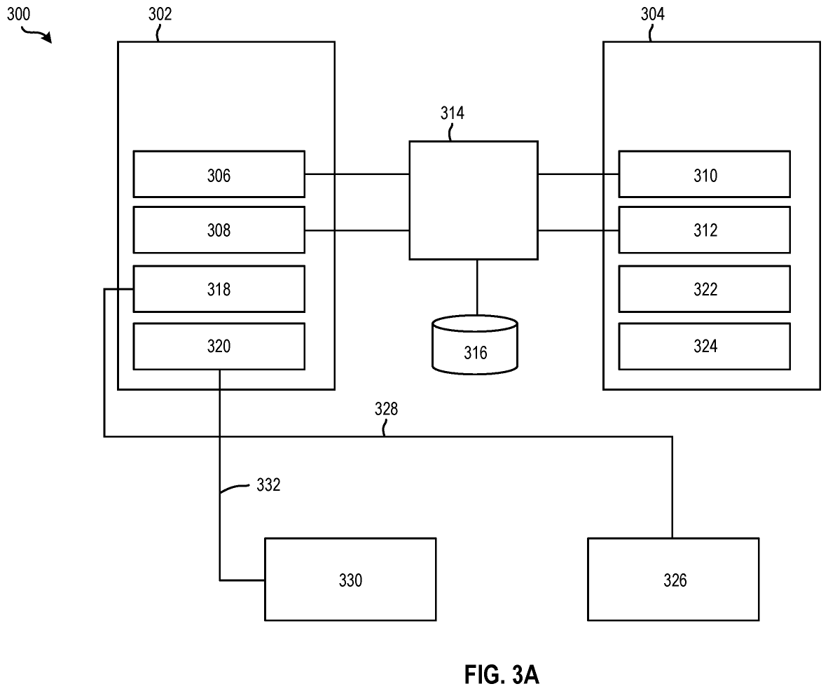

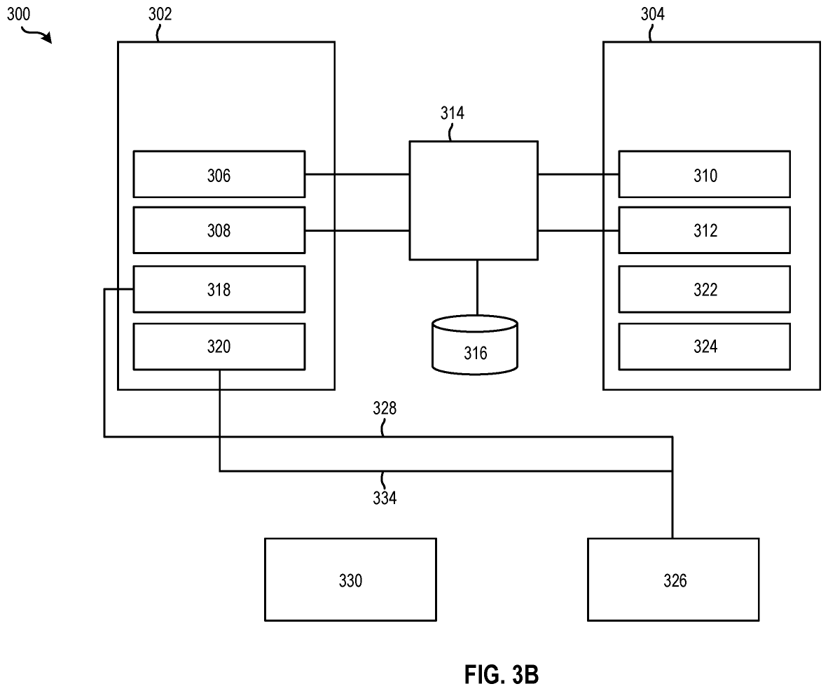

FIGS. 3A-3B depicts a virtual server deployment 300, in accordance with one embodiment. As an option, the present virtual server deployment 300 may be implemented in conjunction with features from any other embodiment listed herein, such as those described with reference to the other FIGS. Of course, however, such virtual server deployment 300 and others presented herein may be used in various applications and/or in permutations which may or may not be specifically described in the illustrative embodiments listed herein. Further, the virtual server deployment 300 presented herein may be used in any desired environment.

Referring first to FIG. 3A, in some approaches, the virtual server deployment 300 may include a known type of controlling system that is modified to be configured to cause, e.g., issue instructions, one or more of the operations described in method 201 to be performed. The controlling system may communicate with one or more computers, e.g., such as computer devices of a first virtual server 302 and/or a computer device of a second virtual server 304. Each of the virtual servers may include at least one physical fiber channel adapter, e.g., see fibre channel adapters 306, 308, 310 and 312, which may be of a known type. Such adapters may communicate with a storage area network 314 that is connected to physical storage 316. Each of the virtual servers may additionally and/or alternatively include at least one server virtual fibre channel adapter, e.g., see server virtual fibre channel adapters 318, 320, 322 and 324. The server virtual fibre channel adapters be connected with one or more VMs via at least one pathway. For example, the server virtual fibre channel adapter 318 is connected with a first VM 326 via at a first path 328. It may be assumed that the first VM 326 is assigned a relatively higher priority. Furthermore, the server virtual fibre channel adapter 320 is connected with a second VM 330 via at a second path 332. It may be assumed that the second VM 330 is assigned a relatively lower priority. Pathing information may be obtained for the VMs 326, 330.

Referring now to FIG. 3B, it may be assumed that a determination has been made that a free virtual FC does not exist that could otherwise be used to serve the first VM 326, e.g., serve as a redundant path to connect the first VM 326 to the first virtual server 302 for purposes of recovering from a disaster recovery event in the event that the first path 328 fails. Accordingly, it is determined, from the pathing information, that the second path 332 serving the second VM 330 is assigned a relatively lower priority than the priority assigned to the of the first VM 326, and is available to be reconfigured to serve the first VM 326. This reconfiguring includes performing a path takeover for reconfiguring the second path 332 to serve the first VM 326. For example, as a result of the takeover process a third path 334 is established that serves the first VM 326.

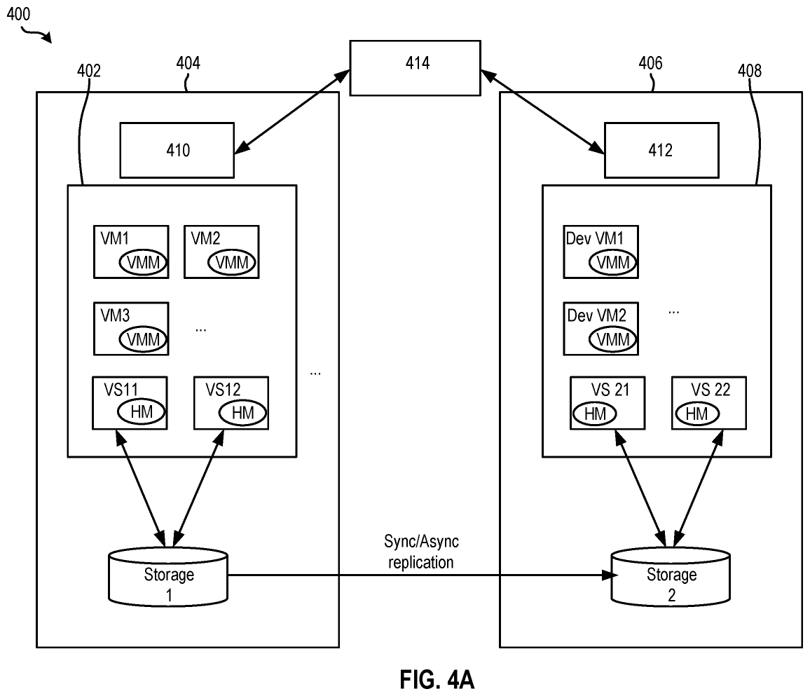

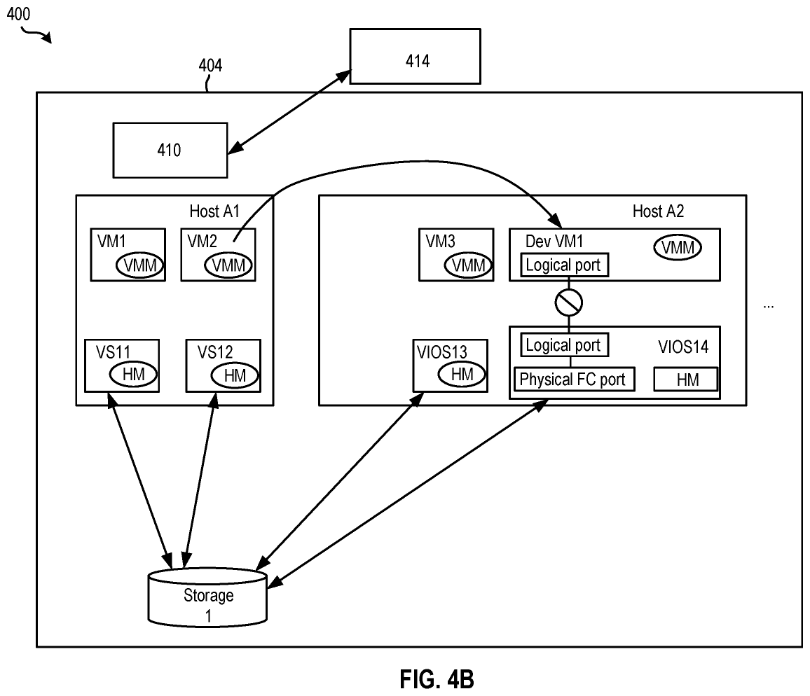

FIGS. 4A-4B depicts a topology 400 of clusters of a system which may include virtual server (VS) deployment, in accordance with one embodiment. As an option, the present VS topology 400 may be implemented in conjunction with features from any other embodiment listed herein, such as those described with reference to the other FIGS. Of course, however, such topology 400 and others presented herein may be used in various applications and/or in permutations which may or may not be specifically described in the illustrative embodiments listed herein. Further, the topology 400 presented herein may be used in any desired environment.

Referring first to the topology 400 in FIG. 4A, an orchestrator 414 is shown in communication with managers 410, 412 of a first cluster 404 which may be assumed to be a data center site and a second cluster 406 which may be assumed to be a disaster recovery site. Each of the clusters 404, 406 include hosts, e.g., see 402 and 408, and each of the hosts 402, 408 include a plurality of VMs, e.g., see VM1, VM2, VM3, Dev VM1, Dev VM2, having managers, e.g., see VMM. The clusters 404, 406 also include virtual servers, e.g., see VS11, VS12, VS21, VS22, each having a hardware manager, e.g., see HM. The VS of the host 402 are in communication with a storage component, e.g., see Storage 1, which may be of a known type of storage. Similarly, the VS of the host 408 are in communication with a storage component, e.g., see Storage 2, which may be of a known type of storage.

With continued reference to FIG. 4A, it may be assumed that a communication path exists that flows from the orchestrator 414 to the managers to the VSs, e.g., via the HMs, to the VMs, e.g., an agent of the VM. It may also be assumed for purposes of an example that in one approach, the orchestrator 414 maintains a table that includes priorities assigned to the VMs. For example, it may be assumed that VM1, VM2 and VM3 are assigned relatively high priorities, and Dev VM1 and Dev VM2 are assigned relatively low priorities.

VM1 and VM3 are served by VS11 and VS12. An FC may be rerouted from the VSs to the higher priority VMs. The routing information is maintained by an external orchestrator 414. For example, referring now to the topology 400 in FIG. 4B, a VM move and takeover is illustrated according to one illustrative approach. In FIG. 4B, a failure is identified, e.g., by the external orchestrator 414 for VM2. From all of the available pathing information from all of the hosts, it is determined that Host A2 is a target. However, it may also be determined that paths are being used by Dev VM1 which is assigned a relatively lower priority. A path takeover is initiated, e.g., by a command issued by the external orchestrator 414 to free the path being used by Dev VM1. Note that the path being freed is represented by the strike in the logical path between the logical ports of Dev VM1 and VS14. Subsequent to the path being freed, an FC path for VM2 is configured on VS14, and VM2 is restarted on Host A2, e.g., see arrow from Host A1 to Host A2.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
assigning a priority to virtual machines (VMs);
obtaining pathing information for the VMs; and
selecting at least one of the VMs assigned a relatively higher priority over at least one of the VMs assigned a relatively lower priority to perform a process.

2. The computer-implemented method of claim 1, wherein selecting at least one of the VMs assigned a relatively higher priority over at least one of the VMs assigned a relatively lower priority to perform the process includes: determining whether a first one of the VMs is without path(s) and/or is moving hosts.

3. The computer-implemented method of claim 2, wherein selecting at least one of the VMs assigned a relatively higher priority over at least one of the VMs assigned a relatively lower priority to perform the process includes:
in response to a determination that the first VM is without path(s) and/or is moving hosts, determining whether the first VM is assigned the relatively higher priority,
in response to a determination that the first VM is assigned the relatively higher priority, determining whether a free virtual fiber channel (FC) exists, and
in response to a determination that a free virtual fiber channel (FC) exists, configuring the first VM to be served by the free virtual FC.

4. The computer-implemented method of claim 3, wherein selecting at least one of the VMs assigned a relatively higher priority over at least one of the VMs assigned a relatively lower priority to perform the process includes:
in response to a determination that a free virtual FC does not exist to serve the first VM, determining, from the pathing information, whether a first path serving a second VM assigned a relatively lower priority than the priority assigned to the first VM is available to be reconfigured to serve the first VM.

5. The computer-implemented method of claim 4, wherein selecting at least one of the VMs assigned a relatively higher priority over at least one of the VMs assigned a relatively lower priority to perform the process includes:
in response to a determination that the first path is available to be reconfigured to serve the first VM, performing a first path takeover for reconfiguring the first path to serve the first VM.

6. The computer-implemented method of claim 5, wherein performing the first path takeover includes: informing the second VM of the first path takeover, failing the first path, removing mapping to the second VM, assigning the mapping to the first VM, and enabling the first VM to pick up the first path.

7. The computer-implemented method of claim 6, comprising: determining whether the failed first path has been restored; and in response to a determination that the failed first path has been restored, reverting the first path takeover.

8. The computer-implemented method of claim 6, wherein a third VM is assigned a relatively lower priority than the priority assigned to the second VM, wherein selecting at least one of the VMs assigned a relatively higher priority over at least one of the VMs assigned a relatively lower priority to perform the process includes:
determining, from the pathing information, whether a second path serving the third VM is available to be reconfigured to serve the second VM,
in response to a determination that the second path is available to be reconfigured to serve the second VM, performing a second path takeover for reconfiguring the second path to serve the second VM.

9. The computer-implemented method of claim 8, wherein performing the second path takeover includes: informing the third VM of the second path takeover, failing the second path, removing mapping to the third VM, assigning the mapping to the second VM, and enabling the second VM to pick up the second path.

10. The computer-implemented method of claim 9, comprising: determining whether the failed second path has been restored; and in response to a determination that the failed second path has been restored, reverting the second path takeover.

11. A computer program product, the computer program product comprising a computer readable storage medium having program instructions embodied therewith, the program instructions readable and/or executable by a computer to cause the computer to:
assign, by the computer, a priority to virtual machines (VMs);
obtain, by the computer, pathing information for the VMs; and
select, by the computer, at least one of the VMs assigned a relatively higher priority over at least one of the VMs assigned a relatively lower priority to perform a process.

12. The computer program product of claim 11, wherein selecting at least one of the VMs assigned a relatively higher priority over at least one of the VMs assigned a relatively lower priority to perform the process includes: determining whether a first one of the VMs is without path(s) and/or is moving hosts.

13. The computer program product of claim 12, wherein selecting at least one of the VMs assigned a relatively higher priority over at least one of the VMs assigned a relatively lower priority to perform the process includes:
in response to a determination that the first VM is without path(s) and/or is moving hosts, determining whether the first VM is assigned the relatively higher priority,
in response to a determination that the first VM is assigned the relatively higher priority, determining whether a free virtual fiber channel (FC) exists, and
in response to a determination that a free virtual fiber channel (FC) exists, configuring the first VM to be served by the free virtual FC.

14. The computer program product of claim 13, wherein selecting at least one of the VMs assigned a relatively higher priority over at least one of the VMs assigned a relatively lower priority to perform the process includes:
in response to a determination that a free virtual FC does not exist to serve the first VM, determining, from the pathing information, whether a first path serving a second VM assigned a relatively lower priority than the priority assigned to the first VM is available to be reconfigured to serve the first VM.

15. The computer program product of claim 14, wherein selecting at least one of the VMs assigned a relatively higher priority over at least one of the VMs assigned a relatively lower priority to perform the process includes:
in response to a determination that the first path is available to be reconfigured to serve the first VM, performing a first path takeover for reconfiguring the first path to serve the first VM.

16. The computer program product of claim 15, wherein performing the first path takeover includes: informing the second VM of the first path takeover, failing the first path, removing mapping to the second VM, assigning the mapping to the first VM, and enabling the first VM to pick up the first path.

17. The computer program product of claim 16, the program instructions readable and/or executable by the computer to cause the computer to: determine, by the computer, whether the failed first path has been restored; and in response to a determination that the failed first path has been restored, revert, by the computer, the first path takeover.

18. The computer program product of claim 16, wherein a third VM is assigned a relatively lower priority than the priority assigned to the second VM, wherein selecting at least one of the VMs assigned a relatively higher priority over at least one of the VMs assigned a relatively lower priority to perform the process includes:
determining, from the pathing information, whether a second path serving the third VM is available to be reconfigured to serve the second VM,
in response to a determination that the second path is available to be reconfigured to serve the second VM, performing a second path takeover for reconfiguring the second path to serve the second VM.

19. The computer program product of claim 18, wherein performing the second path takeover includes: informing the third VM of the second path takeover, failing the second path, removing mapping to the third VM, assigning the mapping to the second VM, and enabling the second VM to pick up the second path.

20. A system, comprising:
a processor; and
logic integrated with the processor, executable by the processor, or integrated with and executable by the processor, the logic being configured to:
assign a priority to virtual machines (VMs);
obtain pathing information for the VMs; and
select at least one of the VMs assigned a relatively higher priority over at least one of the VMs assigned a relatively lower priority to perform a process.
